(19) United States
(12) Patent Application Publication
(10) Pub. No.: US 2012/0300058 A1
(43) Pub. Date: Nov. 29, 2012

(54) CONTROL COMPUTER AND METHOD FOR REGULATING MECHANICAL ARM USING THE SAME

(75) Inventors: SHEN-CHUN LI, Tu-Cheng (TW); CHUN-NENG LIAO, Tu-Cheng (TW); CHENG-HSIEN LEE, Tu-Cheng (TW); SHOU-KUO HSU, Tu-Cheng (TW)

(73) Assignee: HON HAI PRECISION INDUSTRY CO., LTD., Tu-Cheng (TW)

(21) Appl. No.: 13/409,119

(22) Filed: Mar. 1, 2012

(30) Foreign Application Priority Data
May 23, 2011 (TW) 100117894

(51) Int. Cl. H04N 7/18

(52) U.S. Cl. 348/95; 348/E07.085

(57) ABSTRACT

In a method for regulating a mechanical arm using a control computer. The method obtains a first position and a second position of a center of an image plane of an image capturing device on the mechanical arm by controlling movements of the mechanical arm, and calculates a movement vector from the first position to the second position. The method further calculates a regulating angle according to the movement vector and an axial vector of the mechanical arm, and moves the mechanical arm according to the regulating angle such that the axial vector is perpendicular to a measurement plane determined by the first object and the second object.

### BACKGROUND

1. Technical Field

Embodiments of the present disclosure relate to mechanical control technology, and particularly to a control computer and method for regulating a mechanical arm using the control computer.

2. Description of Related Art

Signal testing of components on an electronic device (e.g., a motherboard) is an important step in a manufacturing process of the components or the electronic device. In one example, testing of characteristic impedances of the components on the electronic device may be carried out using a time domain reflectometer (TDR). For example, movements of the TDR are automatic by means of a mechanical arm. However, such a mechanical arm has to be regulated manually. Therefore, a more efficient method for regulating the mechanical arm is desired.

### BRIEF DESCRIPTION OF THE DRAWINGS

FIG. 1 is a schematic diagram of one embodiment of a control computer in electronic connection with a mechanical arm and an image capturing device.

FIG. 2 is a block diagram of one embodiment of the control computer including a regulating system.

FIG. 3 is a block diagram of function modules of the regulating system included in the control computer.

FIGS. 4A-4B are flowcharts of one embodiment of a method for regulating the mechanical arm using the control computer.

FIG. 5 is a two dimensional (2D) diagram of one embodiment of an image plane of the image capturing device and a plurality of objects under test.

FIG. 6 is a three dimensional (3D) diagram of one embodiment of the image plane of the image capturing device and the objects under test.

### DETAILED DESCRIPTION

All of the processes described below may be embodied in, and fully automated via, functional code modules executed by one or more general purpose electronic devices or processors. The code modules may be stored in any type of non-transitory computer-readable medium or other storage device. Some or all of the methods may alternatively be embodied in specialized hardware. Depending on the embodiment, the non-transitory computer-readable medium may be a hard disk drive, a compact disc, a digital video disc, a tape drive or other suitable storage medium.

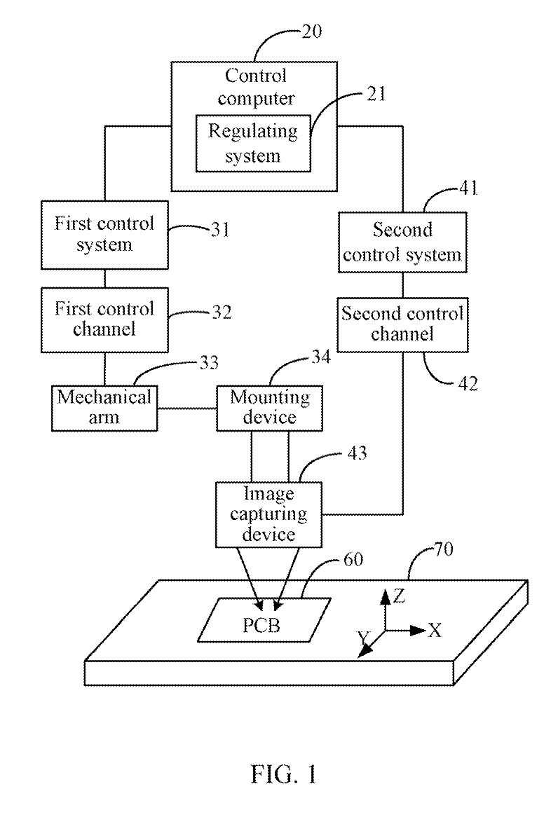

FIG. 1 is a schematic diagram of one embodiment of a control computer 20 in electronic connection with a mechanical arm 33 and an image capturing device 43. The control computer 20 controls movements of the mechanical arm 33 through a first control system 31 and a first control channel 32, and controls movements of the image capturing device 43 through a second control system 41 and a second control channel 42. For example, the first control system 31 may be a control system that controls the movements of the mechanical arm 33, the second control system 41 may be a control system that controls the movements of the image capturing device 43, the first control channel 32 and the second control channel 42 may be communication cables.

The image capturing device 43 is positioned on the mechanical arm 33 by means of a mounting device 34. For example, the mounting device 34 may be a mounting bracket. The image capturing device 43 is used to capture images of objects under test. For example, the object may be a resistor of a printed circuit board (PCB) 60 on a test table 70, as shown in FIG. 1.

In one embodiment, a regulating system 21 is installed in the control computer 20. The regulating system 21 is used to control the movements of the mechanical arm 33 such that an axial vector of a flange face of the mechanical arm 33 is perpendicular to a measurement plane determined by the objects under test. A detailed description follows.

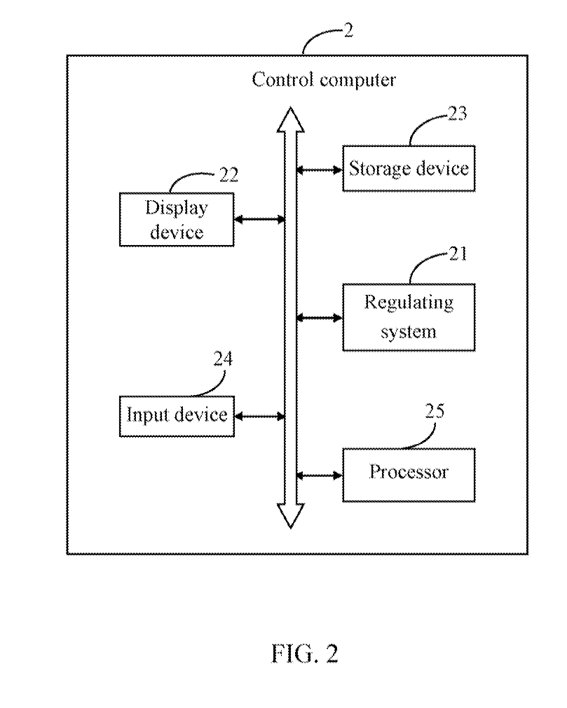

FIG. 2 is a block diagram of one embodiment of the control computer 20 including the regulating system 21. The control computer 20 includes the regulating system 21, a display device 22, a storage device 23, an input device 24, and at least one processor 25. The control computer 20 may be a computer, a server, a tablet device, a mobile phone, or any other computing device. FIG. 2 illustrates only one example of the control computer 20 that may include more or fewer components than as illustrated, or a different configuration of the various components may exist in other embodiments.

The display device 22 may be a liquid crystal display (LCD) or a cathode ray tube (CRT) display, and the input device 24 may be a mouse, a keyboard, a touch screen, and/or a touchpad used for input.

In one embodiment, the regulating system 21 may include computerized instructions in the form of one or more programs that are executed by the at least one processor 25 and stored in the storage device 23 (or other memory).

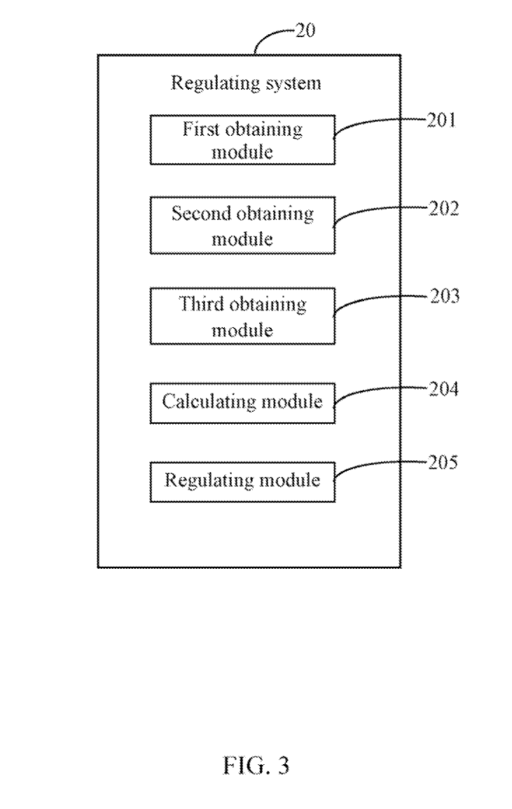

FIG. 3 is a block diagram of function modules of the regulating system 21 included in the control computer 20. In one embodiment, the regulating system 21 may include one or more modules, as for example, a first obtaining module 201, a second obtaining module 202, a third obtaining module 203, a calculating module 204, and a regulating module 205. In general, the word “module”, as used herein, refers to logic embodied in hardware or firmware, or to a collection of software instructions, written in a programming language, such as, Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable medium include CDs, DVDs, BLU-RAY, flash memory, and hard disk drives.

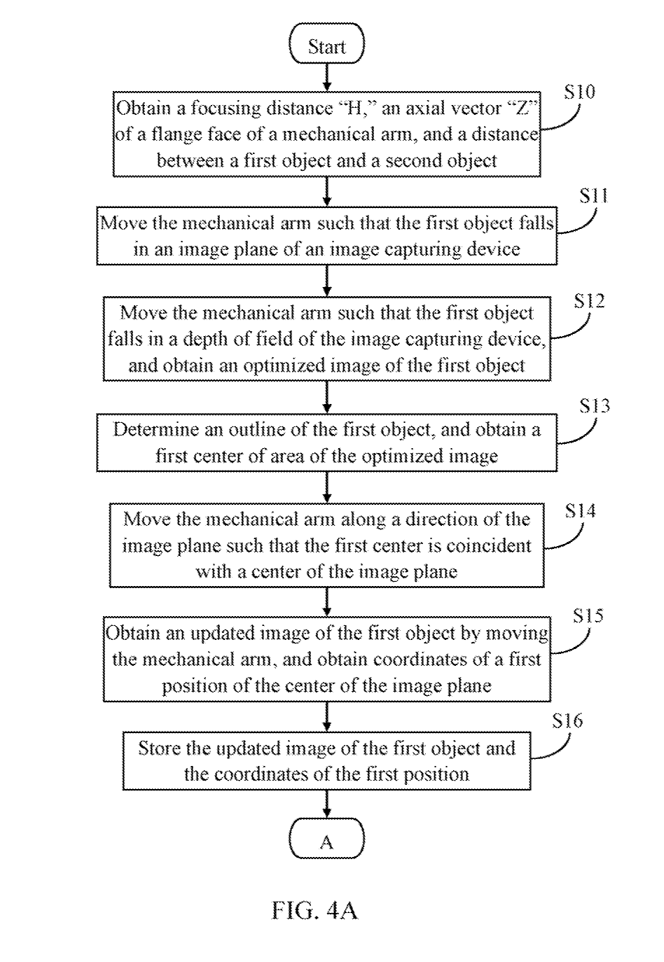

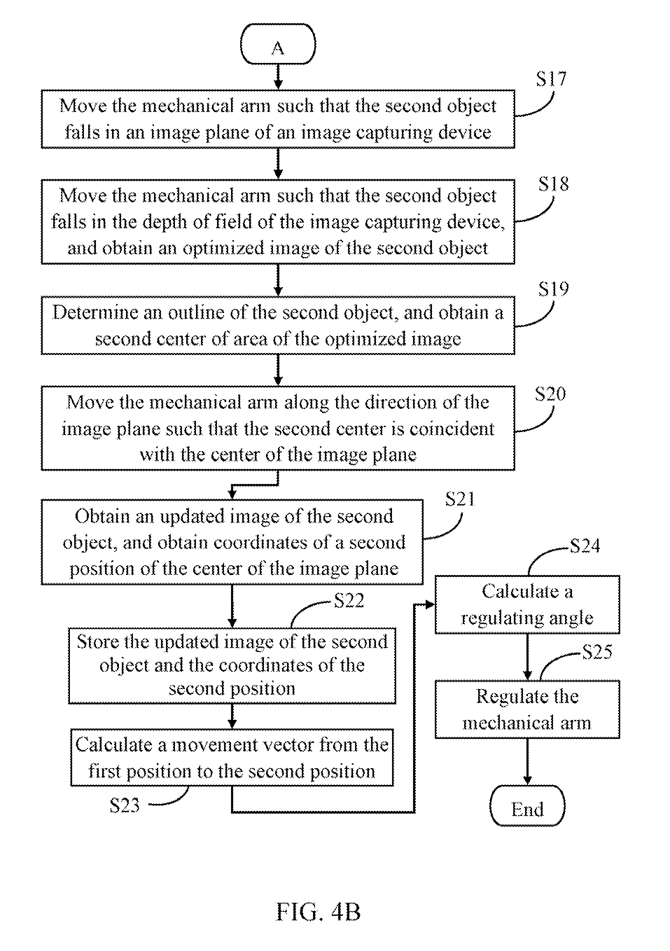

FIGS. 4A-4B are flowcharts of one embodiment of a method for regulating the mechanical arm 33 using the control computer 20. Depending on the embodiment, additional blocks may be added, others removed, and the ordering of the blocks may be changed.

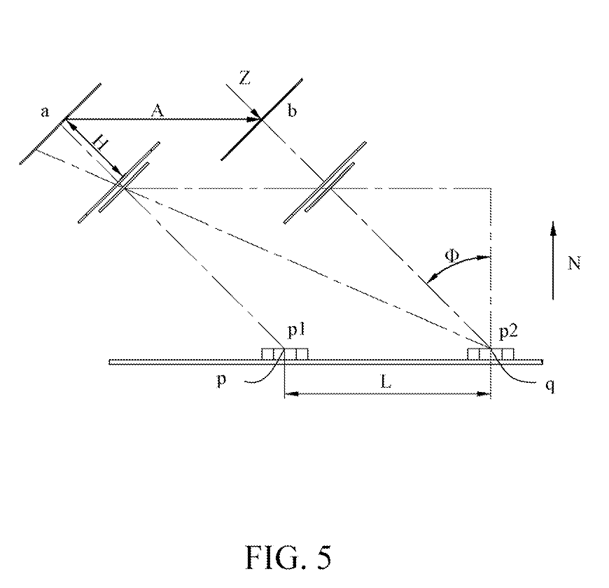

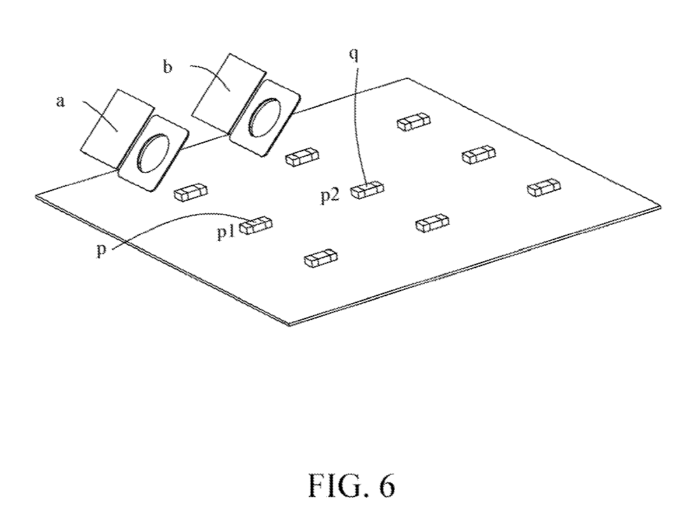

In block S10, the first obtaining module 201 obtains regulating parameters, such as a focusing distance “H” of the image capturing device 43, the axial vector of the flange face of the mechanical arm 33 (hereinafter referred to as “axial vector of the mechanical arm”), and a distance between a first object and a second object on the PCB 60. In one embodiment, the focusing distance “H” and the axial vector of the mechanical arm 33 are pre-stored in the storage device 23. The first object and the second object are predetermined by a user, the distance between the first object and the second object is calculated according to coordinates of the two objects. The coordinates of the first object and the second object are pre-stored in the storage device 23. The focusing distance “H” of the image capturing device 43 is a distance between an object (e.g., the first object) under test and a lens module of the image capturing device 43. The axial vector of the mechanical arm 33 may include an angle from the vertical at which the end or facing flange of the mechanical arm 33 is aimed squarely at the center of the top surface of the object under test. Referring to FIG. 5 and FIG. 6, “p1” represents the first object, and “p2” represents the second object.

In block S11, the second obtaining module 202 moving the mechanical arm 33 such that the first object “p1” falls (e.g., visually falls) in an image plane of the image capturing device 43, and keeps the axial vector of the mechanical arm 33 unchanged. In one embodiment, the image capturing device 43 captures images of “p1” in a shallow depth of field. In another embodiment, the image capturing device 43 may capture images of “p1” in a large depth of field. In one embodiment, in optics, the depth of field (DOF) related to photography is a distance between the nearest and farthest objects in a scene that appear acceptably sharp (sharp enough to be recognizable) in an image.

In block S12, the second obtaining module 202 moving the mechanical arm 33 such that the first object “p1” falls in a depth of a field of the image capturing device 43, and obtains an optimized image of the first object “p1” by adjusting the focusing distance “H” of the image capturing device 43. For example, the optimized image may be a captured image having a definition value (or clarity value) being greater than a preset value (e.g., 480). In one embodiment, the second obtaining module 202 obtains the optimized image of the first object “p1” by controlling the image capturing device 43 to capture images of the first object “p1” until the definition value (or clarity value) of the first object “p1” in the captured image is greater than the preset value.

In block S13, the second obtaining module 202 determines an outline of the first object “p1” in the optimized image of the first object “p1”, and obtains a first center of area of the optimized image of the first object “p1.” Referring to FIG. 5 and FIG. 6, “p” represents the first center of area of the optimized image of the first object “p1”.

In block S14, the second obtaining module 202 moves the mechanical arm 33 along a direction of the image plane such that the first center “p” is coincident with a center of the image plane of the image capturing device 43.

In block S15, the second obtaining module 202 obtains an updated image of the first object “p1” by moving the mechanical arm 33, and obtains coordinates of a first position of the center of the image plane. In one embodiment, the definition value of the first object “p1” in the updated image of the first object “p1” is greater than the preset value. Referring to FIG. 5 and FIG. 6, “a” represents the first position of the center of the image plane of the image capturing device 43.

In block S16, the second obtaining module 202 stores the updated image of the first object “p1” and the coordinates of the first position “a” of the center of the image plane in the storage device 23.

In block S17, the third obtaining module 203 moves the mechanical arm 33 according to a distance “L” between the first object “p1” and the second object “p2” such that the second object “p2” falls in the image plane of the image capturing device 43, and keeps the axial vector of the mechanical arm 33 unchanged.

In block S18, the third obtaining module 203 moves the mechanical arm 33 such that the second object “p2” falls in the depth of field of the image capturing device 43, and obtains an optimized image of the second object “p2” by adjusting the focusing distance “H” of the image capturing device 43. In one embodiment, the third obtaining module 203 obtains the optimized image of the second object “p2” by controlling the image capturing device 43 to capture images of the second object “p2” until the definition value of the captured image of the second object “p2” is greater than the preset value.

In block S19, the third obtaining module 203 determines an outline of the second object “p2” in the optimized image of the second object “p2”, and obtains a second center of area of the optimized image of the second object “p2.” Referring to FIG. 5 and FIG. 6, “q” represents the second center of area of the optimized image of the second object “p2”.

In block S20, the third obtaining module 203 moves the mechanical arm 33 along the direction of the image plane such that the second center “q” is coincident with the center of the image plane of the image capturing device 43.

In block S21, the third obtaining module 203 obtains an updated image of the second object “p2” by moving the mechanical arm 33, and obtains coordinates of a second position of the center of the image plane. In one embodiment, the definition value of the second object “p2” in the updated image of the second object “p2” is greater than the preset value. Referring to FIG. 5 and FIG. 6, “b” represents the second position of the center of the image plane of the image capturing device 43.

In block S22, the third obtaining module 203 stores the updated image of the second object “p2” and the coordinates of the second position “b” of the center of the image plane in the storage device 23.

In block S23, the calculating module 204 calculates a movement vector from the first position “a” to the second position “b” according to the coordinates of the first position “a” and the second position “b”. Referring to FIG. 5, “A” represents the movement vector (including distance and movement) from the first position “a” to the second position “b”.

In block S24, the calculating module 204 calculates a regulating angle according to the movement vector “A” (vector “A”) and the axial vector “Z”. In detail, the calculating module 204 calculates an included angle between the vector “A” and the axial vector “Z,” and obtains the regulating angle by calculating a difference between ninety degrees and the included angle. Referring to FIG. 5, “Φ” represents the regulating angle. Supposing that “β” is the included angle between the vector “A” and the axial vector “Z,” then Φ=90−β.

In block S25, the regulating module 205 moves the mechanical arm 33 according to the regulating angle “Φ” such that the axial vector “Z” is perpendicular to a measurement plane determined by the first object “p1” and the second object “p2”. In one embodiment, the measurement plane is coplanar with the PCB 60. The mechanical arm 33 is regulated by rotating the mechanical arm 33 in a clockwise direction with the regulating angle “Φ” such that the axial vector “Z” be parallel to a normal vector of the measurement plane. Referring to FIG. 5, “N” represents the normal vector of the measurement plane determined by the first object “p1” and the second object “p2”.

It should be emphasized that the above-described embodiments of the present disclosure, particularly, any embodiments, are merely possible examples of implementations, merely set forth for a clear understanding of the principles of the disclosure. Many variations and modifications may be made to the above-described embodiment(s) of the disclosure without departing substantially from the spirit and principles of the disclosure. All such modifications and variations are intended to be included herein within the scope of this disclosure and the present disclosure and protected by the following claims.

What is claimed is:

1. A computer-implemented method for regulating a mechanical arm using a control computer, the method comprising:
obtaining an axial vector of a flange face of the mechanical arm, and a distance between a first object and a second object of an electronic device on a test table;
obtaining an optimized image of the first object using an image capturing device on the mechanical arm by controlling movements of the mechanical arm, and obtaining coordinates of a first position of a center of an image plane of the image capturing device;
obtaining an optimized image of the second object using the image capturing device by controlling movements of the mechanical arm according to the distance between the first object and the second object, and obtaining coordinates of a second position of the center of the image plane of the image capturing device;
calculating a movement vector from the first position to the second position according to the coordinates of the first position and the second position, and calculating a regulating angle according to the movement vector and the axial vector of the flange face of the mechanical arm; and
moving the mechanical arm according to the regulating angle such that the axial vector is perpendicular to a measurement plane determined by the first object and the second object.

2. The method according to claim 1, wherein the first position of the center of the image plane of the image capturing device is obtained by:
moving the mechanical arm such that the first object visually falls in the image plane of the image capturing device, and keeping the axial vector of the flange face of the mechanical arm unchanged;
moving the mechanical arm such that the first object visually falls in a depth of field of the image capturing device, and obtaining the optimized image of the first object by adjusting a focusing distance of the image capturing device;
determining an outline of the first object, and obtaining a first center of area of the optimized image of the first object;
moving the mechanical arm along a direction of the image plane such that the first center is coincident with a center of the image plane of the image capturing device;
obtaining an updated image of the first object by moving the mechanical arm, and obtaining coordinates of a first position of the center of the image plane, a definition value of the first object in the updated image of the first object being greater than a preset value; and
storing the updated image of the first object and the coordinates of the first position of the center of the image plane into a storage device of the control computer.

3. The method according to claim 1, wherein the second position of the center of the image plane of the image capturing device is obtained by:
moving the mechanical arm according to the distance between the first object and the second object such that the second object visually falls in the image plane of the image capturing device, and keeping the axial vector of the flange face of the mechanical arm unchanged;
moving the mechanical arm such that the second object visually falls in a depth of field of the image capturing device, and obtaining the optimized image of the second object by adjusting a focusing distance of the image capturing device;
determining an outline of the second object, and obtaining a second center of area of the optimized image of the second object;
moving the mechanical arm along a direction of the image plane such that the second center is coincident with a center of the image plane of the image capturing device;
obtaining an updated image of the second object by moving the mechanical arm, and obtaining coordinates of a second position of the center of the image plane, a definition value of the second object in the updated image of the second object being greater than a preset value; and
storing the updated image of the second object and the coordinates of the second position of the center of the image plane into a storage device of the control computer.

4. The method according to claim 1, wherein the regulating angle is calculated by:
calculating an included angle between the movement vector and the axial vector of the flange face of the mechanical arm; and
obtaining the regulating angle by calculating a difference between ninety degrees and the included angle.

5. The method according to claim 1, wherein the mechanical arm is regulated by:
rotating the mechanical arm in a clockwise direction with the regulating angle such that the axial vector be parallel to a normal vector of the measurement plane determined by the first object and the second object.

6. A control computer, comprising:
a storage device;
at least one processor; and
one or more modules that are stored in the storage device and executed by the at least one processor, the one or more modules comprising:
a first obtaining module that obtains an axial vector of a flange face of a mechanical arm, and a distance between a first object and a second object of an electronic device on a test table;
a second obtaining module that obtains an optimized image of the first object using an image capturing device on the mechanical arm by controlling movements of the mechanical arm, and obtains coordinates of a first position of a center of an image plane of the image capturing device;
a third obtaining module that obtains an optimized image of the second object using the image capturing device by controlling movements of the mechanical arm according to the distance between the first object and the second object, and obtains coordinates of a second position of the center of the image plane of the image capturing device;
a calculating module that calculates a movement vector from the first position to the second position according to the coordinates of the first position and the second position, and calculates a regulating angle according to the movement vector and the axial vector of the flange face of the mechanical arm; and
a regulating module that moves the mechanical arm according to the regulating angle such that the axial vector is perpendicular to a measurement plane determined by the first object and the second object.

7. The control computer according to claim 6, wherein the first position of the center of the image plane of the image capturing device is obtained by:
moving the mechanical arm such that the first object visually falls in the image plane of the image capturing device by, and keeping the axial vector of the flange face of the mechanical arm unchanged;
moving the mechanical arm such that the first object visually falls in a depth of field of the image capturing device, and obtaining the optimized image of the first object by adjusting a focusing distance of the image capturing device;
determining an outline of the first object, and obtaining a first center of area of the optimized image of the first object;
moving the mechanical arm along a direction of the image plane such that the first center is coincident with a center of the image plane of the image capturing device;
obtaining an updated image of the first object by moving the mechanical arm, and obtaining coordinates of a first position of the center of the image plane, a definition value of the first object in the updated image of the first object being greater than a preset value; and
storing the updated image of the first object and the coordinates of the first position of the center of the image plane into a storage device of the control computer.

8. The control computer according to claim 6, wherein the second position of the center of the image plane of the image capturing device is obtained by:
moving the mechanical arm according to the distance between the first object and the second object such that the second object visually falls in the image plane of the image capturing device, and keeping the axial vector of the flange face of the mechanical arm unchanged;
moving the mechanical arm such that the second object visually falls in a depth of field of the image capturing device, and obtaining the optimized image of the second object by adjusting a focusing distance of the image capturing device;
determining an outline of the second object, and obtaining a second center of area of the optimized image of the second object;
moving the mechanical arm along a direction of the image plane such that the second center is coincident with a center of the image plane of the image capturing device by;
obtaining an updated image of the second object by moving the mechanical arm, and obtaining coordinates of a second position of the center of the image plane, a definition value of the second object in the updated image of the second object being greater than a preset value; and
storing the updated image of the second object and the coordinates of the second position of the center of the image plane into a storage device of the control computer.

9. The control computer according to claim 6, wherein the regulating angle is calculated by:
calculating an included angle between the movement vector and the axial vector of the flange face of the mechanical arm; and
obtaining the regulating angle by calculating a difference between ninety degrees and the included angle.

10. The control computer according to claim 6, wherein the mechanical arm is regulated by: rotating the mechanical arm in a clockwise direction with the regulating angle such that the axial vector be parallel to a normal vector of the measurement plane determined by the first object and the second object.

11. A non-transitory storage medium having stored thereon instructions that, when executed by a processor of a control computer, causes the control computer to perform a method for regulating a mechanical arm, the method comprising:
obtaining an axial vector of a flange face of the mechanical arm, and a distance between a first object and a second object of an electronic device on a test table;
obtaining an optimized image of the first object using an image capturing device on the mechanical arm by controlling movements of the mechanical arm, and obtaining coordinates of a first position of a center of an image plane of the image capturing device;
obtaining an optimized image of the second object using the image capturing device by controlling movements of the mechanical arm according to the distance between the first object and the second object, and obtaining coordinates of a second position of the center of the image plane of the image capturing device;
calculating a movement vector from the first position to the second position according to the coordinates of the first position and the second position, and calculating a regulating angle according to the movement vector and the axial vector of the flange face of the mechanical arm; and
moving the mechanical arm according to the regulating angle such that the axial vector is perpendicular to a measurement plane determined by the first object and the second object.

12. The non-transitory storage medium according to claim 11, wherein the first position of the center of the image plane of the image capturing device is obtained by:
moving the mechanical arm such that the first object visually falls in the image plane of the image capturing device, and keeping the axial vector of the flange face of the mechanical arm unchanged;
moving the mechanical arm such that the first object visually falls in a depth of field of the image capturing device, and obtaining the optimized image of the first object by adjusting a focusing distance of the image capturing device;
determining an outline of the first object, and obtaining a first center of area of the optimized image of the first object;
moving the mechanical arm along a direction of the image plane such that the first center is coincident with a center of the image plane of the image capturing device;
obtaining an updated image of the first object by moving the mechanical arm, and obtaining coordinates of a first position of the center of the image plane, a definition value of the first object in the updated image of the first object being greater than a preset value; and
storing the updated image of the first object and the coordinates of the first position of the center of the image plane into a storage device of the control computer.

13. The non-transitory storage medium according to claim 11, wherein the second position of the center of the image plane of the image capturing device is obtained by:
moving the mechanical arm according to the distance between the first object and the second object such that the second object visually falls in the image plane of the image capturing device, and keeping the axial vector of the flange face of the mechanical arm unchanged;
moving the mechanical arm such that the second object visually falls in a depth of field of the image capturing device, and obtaining the optimized image of the second object by adjusting a focusing distance of the image capturing device;
determining an outline of the second object, and obtaining a second center of area of the optimized image of the second object;
moving the mechanical arm along a direction of the image plane such that the second center is coincident with a center of the image plane of the image capturing device;
obtaining an updated image of the second object by moving the mechanical arm, and obtaining coordinates of a second position of the center of the image plane, a definition value of the second object in the updated image of the second object being greater than a preset value; and
storing the updated image of the second object and the coordinates of the second position of the center of the image plane into a storage device of the control computer.

14. The non-transitory storage medium according to claim 11, wherein the regulating angle is calculated by:
calculating an included angle between the movement vector and the axial vector of the flange face of the mechanical arm; and
obtaining the regulating angle by calculating a difference between ninety degrees and the included angle.

15. The non-transitory storage medium according to claim 11, wherein the mechanical arm is regulated by: rotating the mechanical arm in a clockwise direction with the regulating angle such that the axial vector be parallel to a normal vector of the measurement plane determined by the first object and the second object.

16. The non-transitory storage medium according to claim 11, wherein the medium is selected from the group consisting of a hard disk drive, a compact disc, a digital video disc, and a tape drive.
